(19) United States
(12) Patent Application Publication
(10) Pub. No.: US 2011/0159706 A1
(43) Pub. Date: Jun. 30, 2011

(54) CONNECTOR ASSEMBLY

(75) Inventor: KUN-CHAN WU, Tu-Cheng (TW)

(73) Assignee: HON HAI PRECISION INDUSTRY CO., LTD., Tu-Cheng (TW)

(21) Appl. No.: 12/872,159

(22) Filed: Aug. 31, 2010

(30) Foreign Application Priority Data
Dec. 25, 2009 (TW) 98144914

(51) Int. Cl. H01R 11/30

(52) U.S. Cl. 439/39

(57) ABSTRACT

A connector assembly includes a first connector, a second connector, and a fixing structure for fixing the second connector on the first connector. The first connector includes a main body and a plurality of contact terminals positioned on the main body. The second connector includes a main body and a plurality of contact terminals for contacting the contact terminal of the first connector positioned on the main body. The fixing structure includes a first magnetic member fixed on the main body of the first connector and a first receiving member fixed on the main body of the second connector received in the first magnetic member to fix the second connector on the first connector in a specific orientation.

### BACKGROUND

1. Technical Field

The present disclosure relates to a connector and, particularly, to a connector with magnetic member.

2. Description of the Related Art

A commonly used connector assembly includes a first connector, a second connector and a mechanical latching mechanism including hooks for fixing the second connector on the first connector. However, the first and second connectors must be aligned before the second connector can latch the first connector, requiring visual guidance, thereby complicating use and reducing efficiency.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the views, and both the views are schematic.

FIG. 1 is an isometric view of a first embodiment of a connector assembly.

FIG. 2 is an exploded, isometric view of the connector assembly shown in FIG. 1.

FIG. 3 is an exploded, isometric view of a second embodiment of a connector assembly.

FIG. 4 is an exploded, isometric view of a third embodiment of a connector assembly.

FIG. 5 is an exploded, isometric view of a fourth embodiment of a connector assembly.

FIG. 6 is an exploded, isometric view of a fifth embodiment of a connector assembly.

FIG. 7 is an exploded, isometric view of a sixth embodiment of a connector assembly.

### DETAILED DESCRIPTION

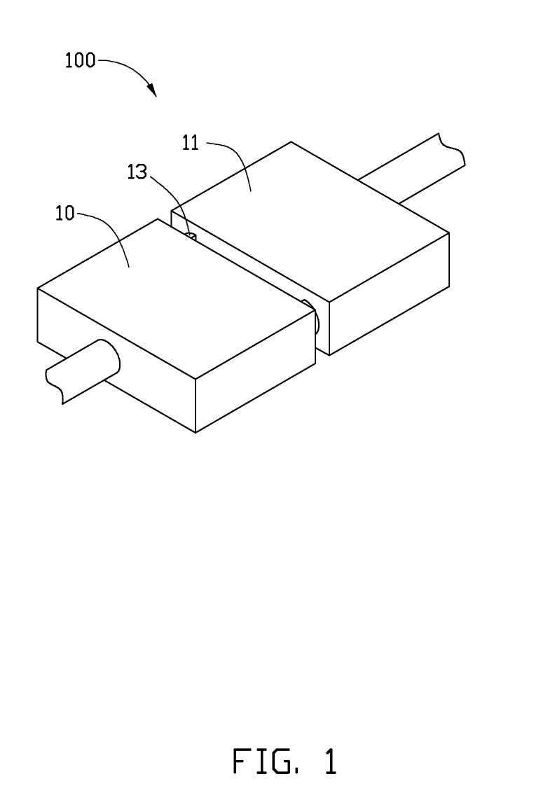

Referring to FIG. 1, a first embodiment of a connector assembly 100 includes a first connector 10, a second connector 11, and a fixing structure 13 for fixing the first connector 10 and the second connector 11 together.

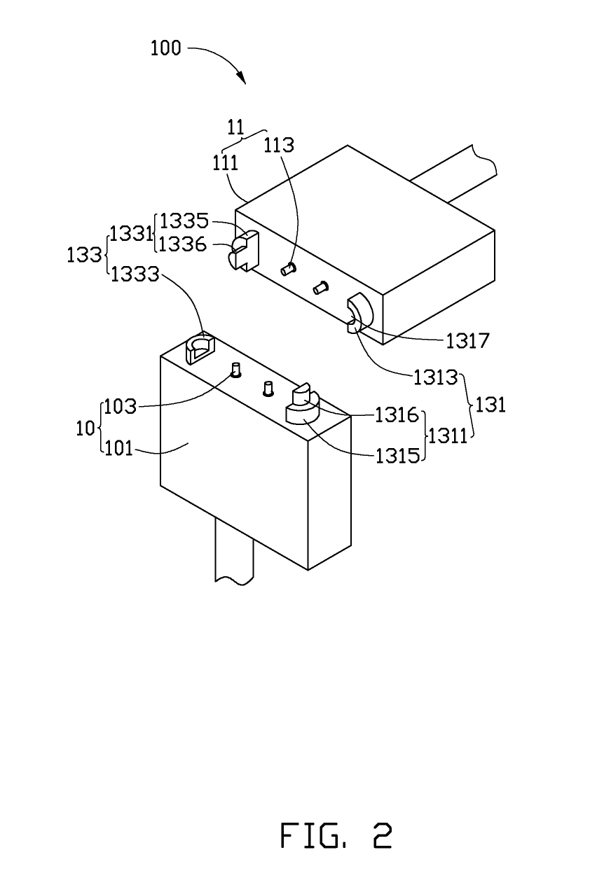

Referring to FIG. 2, the first connector 10 includes a rectangular main body 101, two cylindrical contact terminals 103 moveably positioned on a side surface of the main body 101, and two elastic members (not shown) supporting the two contacting terminals 103 respectively. The contact terminals 103 extend out of the main body 101, and are capable of withdrawing back into the main body 101, thus compressing the elastic members. The second connector 11 is substantially the same as the first connector 10, including a main body 111 and two contact terminals 113 moveably positioned on the main body 111.

The fixing structure 13 includes a first fixing module 131 and a second fixing module 133. The first fixing module 131 includes a first magnetic member 1311 fixed on the first connector 10 and a first receiving member 1313 fixed on the second connector 11. The second fixing assembly 133 includes a second magnetic member 1331 and a second receiving member 1333. In the illustrated embodiment, the first magnetic member 1311 includes a semicircular base portion 1315 fixed on the main body 101 of the first connector 10 and a semicircular positioning portion 1316 formed on a surface of the base portion 1315. A diameter of the base portion 1315 exceeds that of the positioning portion 1316. The first receiving member 1313 is made of iron, fixed on the second connector 11. The first receiving member 1313 defines a receiving groove 1317 for receiving the positioning portion 1316 of the first magnetic member 1311. The second magnetic member 1331 is the same as the first magnetic member 1311 in structure, including a base portion 1335 fixed on the main body 111 of the second connector 11 and a positioning portion 1336. The positioning portion 1336 is formed on a surface of the base portion 1335 away from the main body 101 of the first connector 10. The second receiving member 1333 is also made of iron, fixed on the first connector 11. The second receiving member 1333 is the same as the first receiving member 1313 in structure, defining a receiving groove 1317 for receiving the positioning portion 1336 of the second magnetic member 1331. That is, the first magnetic member 1311 and the first receiving member 1313 provide a complementary engagement, as does the second magnetic member 1331 and the second receiving member 1333. The first magnetic member 1311 and the second receiving member 1333 are fixed on the first connector 10, and the two contact terminals 103 of the first connector 10 are positioned between the first magnetic member 1311 and the second receiving member 1333. The second magnetic member 1331 and the second receiving member 1313 are fixed on the second connector 11, and the contact terminals 113 of the second connector 11 are positioned between second magnetic member 1331 and the first receiving member 1313.

In use, when the second connector 11 approaches the first connector 10, the first receiving member 1313 and the second receiving member 1333 are attracted by the first magnetic member 1311 and the second magnetic member 1331, to connect the first connector 10 and the second connector 11 together. The positioning portion 1316 of the first magnetic member 1311 is received in the receiving groove 1317 of the first receiving member 1313, and the positioning portion 1336 of the second magnetic member 1331 is received in the receiving groove 1337 of the second receiving member 1333 to position the second connector 11 in a specific orientation. Each contact terminal 103 of the first connector 10 is electrically connected to a contact terminal 113 of the second connector 11. The second connector 11 is easily and accurately mounted on the first connector 10 without visual or manual alignment.

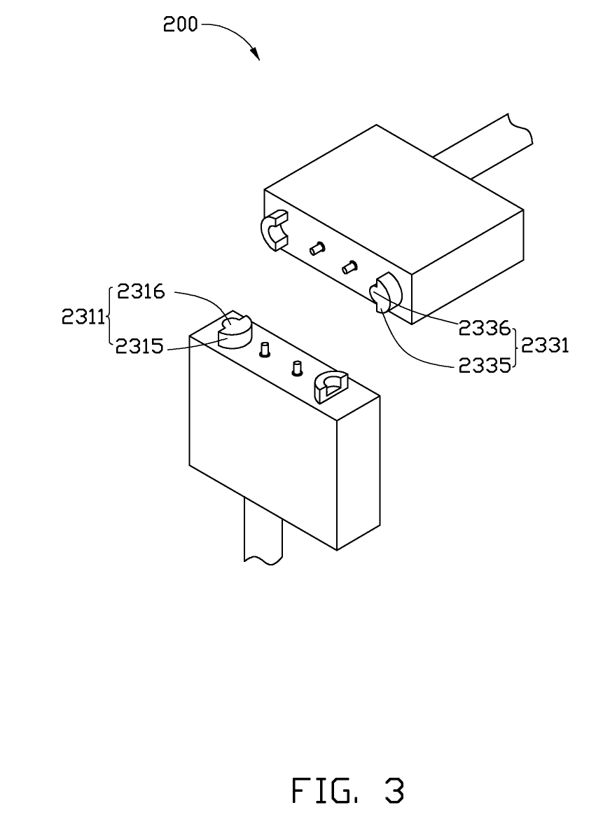

Referring to FIG. 3, a second embodiment of a connector assembly 200 differs from the first embodiment of the connector assembly 100 only in that a positioning portion 2316 of a first magnetic member 2311 of the connector assembly 200 is formed at a side surface of a base portion 2315, and a positioning portion 2336 of a second magnetic member 2331 is formed at a side surface of a base portion 2335.

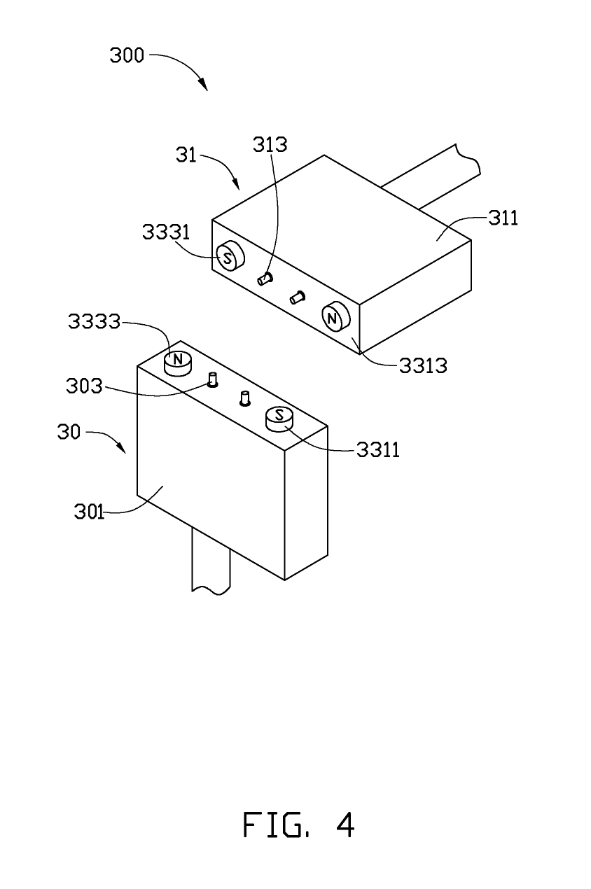

Referring to FIG. 4, a third embodiment of a connector assembly 300 differs from the connector assembly 100 only in that a first magnetic member 3311 is cylindrical with a south pole facing away from the main body 301 of a first connector 30, a second magnetic member 3331 is cylindrical with a south pole facing away from a main body 311 of a second connector 31, a first receiving member 3313 is a cylindrical magnet with a north pole facing away from the main body 311 of the second connector 31, and a second receiving member 3333 is a cylindrical magnet with a north pole facing away from a main body 301 of a first connector 30. A second connector 31 can only be fixed on the first connector 30 by the first magnetic member 3311 received in the first receiving member 3113, and the second magnetic member 3331 received in the second receiving member 3133, to secure contact terminals 303 of the first connector 30 with contact terminals 313 of the second connector 31.

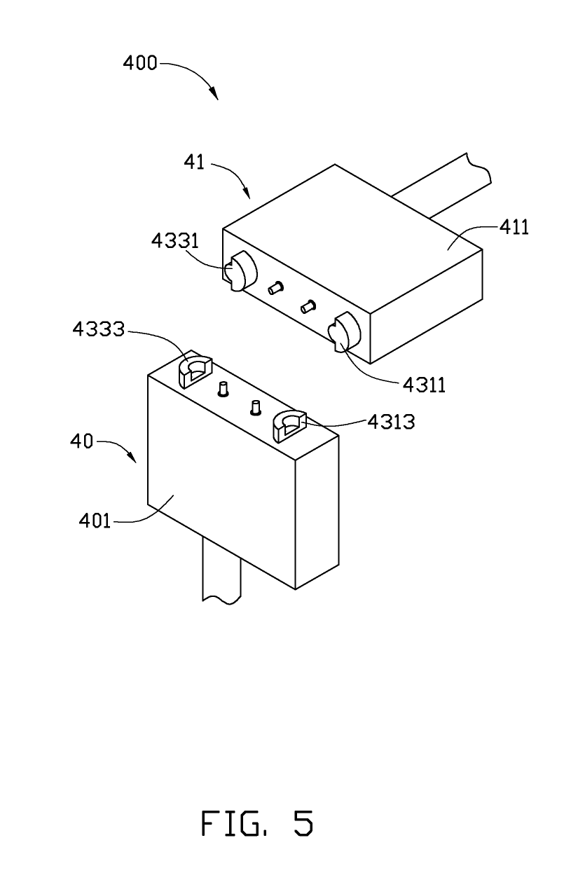

Referring to FIG. 5, a fourth embodiment of connector assembly 400 differs from the second embodiment of the connector assembly 200 only in that a first magnetic member 4311 and a second magnetic member 4331 are fixed on a main body 411 of a second connector 41 and a first receiving member 4313 and a second receiving member 4333 are fixed on a main body 401 of a first connector 40 accordingly.

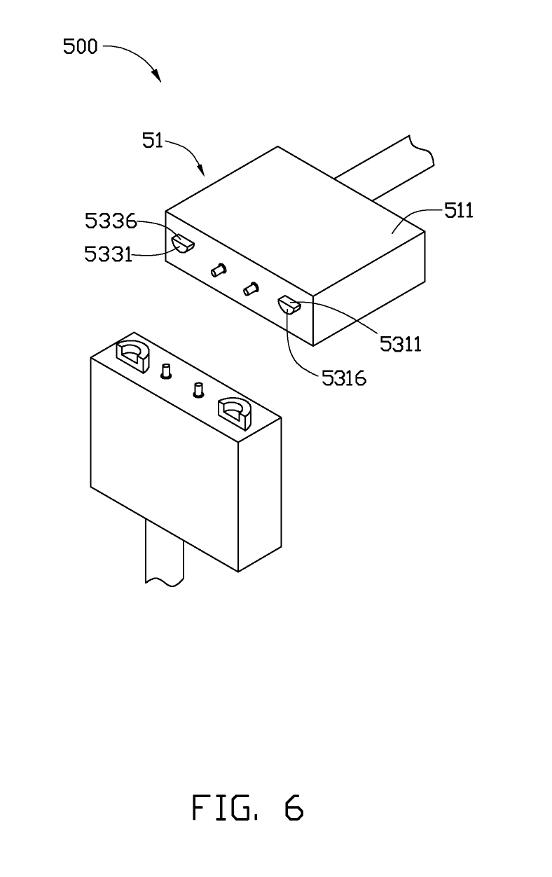

Referring to FIG. 6, a fifth embodiment of connector assembly 500 differs from the fourth embodiment of the connector assembly 400 only in that a first magnetic member 5311 includes only a positioning portion 5316 fixed on a main body 511 of a second connector 51, and a second magnetic member 5331 also includes only a positioning portion 5336 fixed on the main body 511 of the second connector 51.

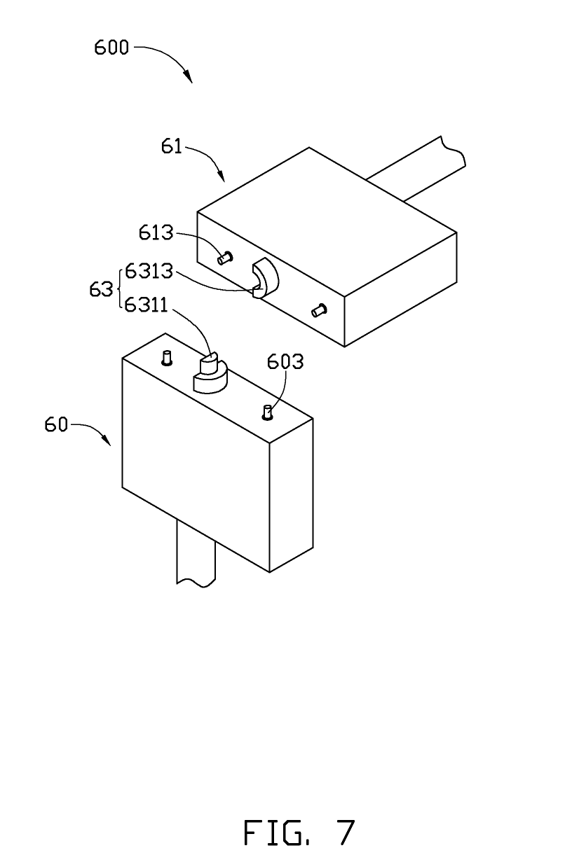

Referring to FIG. 7, a sixth embodiment of a connector assembly 600 differs from the first embodiment of the connector assembly 100 only in that a fixing structure 63 includes only a first magnetic member 6311 and a first receiving member 6313; the first magnetic member 6311 is positioned between two contact terminals 603 of a first connector 60 and the receiving member 6313 is positioned between two contact terminals 613 of a second connector 61.

Finally, while particular embodiments have been described, the description is illustrative and is not to be construed as limiting. For example, various modifications can be made to the embodiments by those of ordinary skill in the art without departing from the true spirit and scope of the invention as defined by the appended claims.

What is claimed is:

1. A connector assembly comprising:
a first connector comprising a main body and a plurality of contact terminals positioned on the main body;
a second connector comprising a main body and a plurality of contact terminals for contacting the contact terminals of the first connector positioned on the main body; and
a fixing structure for fixing the second connector on the first connector, wherein the fixing structure comprises a first magnetic member fixed on the main body of the first connector and a first receiving member fixed on the main body of the second connector and received in the first magnetic member to fix the second connector on the first connector in a specific orientation.

2. The connector assembly of claim 1, wherein the first magnetic member comprises a positioning portion and the receiving member defines a receiving groove for receiving the positioning portion.

3. The connector assembly of claim 2, wherein the first magnetic member further comprises a base portion fixed on the main body of the first connector, on a side surface of which the positioning portion is formed.

4. The connector assembly of claim 2, wherein the first magnetic member further comprises a base portion fixed on a surface of the main body of the first connector away from the main body of the first connector the positioning portion is formed.

5. The connector assembly of claim 3, wherein two contact terminals are formed on the first connector, two contact terminals are formed on the second connector, the first magnetic member is positioned between the two contact terminals of the first connector, and the receiving member is positioned between the two contact terminals of the second connector.

6. The connector assembly of claim 2, wherein the fixing structure further comprises a second magnetic member fixed on the main body of the second connector and a second receiving member fixed on the main body of the first connector and received in the second magnetic member.

7. The connector assembly of claim 2, wherein the fixing structure further comprises a second magnetic member fixed on the main body of the first connector and a second receiving member fixed on the main body of the second connector and received in the second magnetic member.

8. A connector assembly comprising:
a first connector comprising a main body and a plurality of contact terminals positioned on the main body;
a second connector comprising a main body and a plurality of contact terminals for contacting the contact terminals of the first connector positioned on the main body; and
a fixing structure for fixing the second connector on the first connector, wherein the fixing structure comprises a first magnetic member fixed on the main body of the first connector with a south pole facing away from the main body of the first connector, a first receiving member fixed on the main body of the second connector corresponding to the first magnetic member with a north pole facing away from the main body of the second connector, a second magnetic member fixed on the main body of the second connector with a north pole facing away from the main body of the second connector, and a second receiving member fixed on the main body of the first connector corresponding to the second magnetic member with a south pole facing away from the main body of the first connector, to fix the second connector on the first connector in a specific orientation.
